(19) United States
(12) Patent Application Publication
(10) Pub. No.: US 2021/0258757 A1
(43) Pub. Date: Aug. 19, 2021

(54) Emergency Response Communication System

(71) Applicant: Edward McGovern, Miami, FL (US)

(72) Inventor: Edward McGovern, Miami, FL (US)

(21) Appl. No.: 17/178,954

(22) Filed: Feb. 18, 2021

Related U.S. Application Data
(60) Provisional application No. 62/977,855, filed on Feb. 18, 2020.

(51) Int. Cl. H04W 4/90; G06F 16/29; H04W 4/021

(52) U.S. Cl. CPC H04W 4/90; H04W 4/021; G06F 16/29

(57) ABSTRACT

A method for dynamically managing communication during an emergency situation including receiving a dynamic feed of information from a location of the emergency situation, utilizing a processor to determine the location information of the emergency situation and set up a radius around the location, utilizing the processor to transmit notification of the emergency situation messages to law enforcement and first responders located within the radius, providing dynamically generated real time visual assisted communication from a database to law enforcement and first responders within the radius, receiving dynamically generated real time injury reports from the location within the visual assisted communication to law enforcement and first responders within the radius.

### CROSS REFERENCE TO RELATED APPLICATIONS

This application claims priority to U.S. Provisional Application No. 62/977,855 filed Feb. 18, 2020, the entire disclosure of which is hereby incorporated by reference for all proper purposes.

### TECHNICAL FIELD

This invention relates generally to a dynamic communication system between emergency responders.

### SUMMARY OF THE INVENTION

A method for dynamically managing communication during an emergency situation including receiving a dynamic feed of information from a location of the emergency situation, utilizing a processor to determine the location information of the emergency situation and set up a radius around the location, utilizing the processor to transmit notification of the emergency situation messages to law enforcement and first responders located within the radius, providing dynamically generated real time visual assisted communication from a database to law enforcement and first responders within the radius, receiving dynamically generated real time injury reports from the location within the visual assisted communication to law enforcement and first responders within the radius

A computer implemented method (CIM) including dynamically determining a location of the emergency situation, responsive to each dynamic determination: calculating a radius around the location, transmitting notification of the emergency situation to law enforcement and first responders, within the radius, including the location of the emergency situation; providing dynamically generated real time visual assisted communication from a database to law enforcement and first responders within the radius; and receiving dynamically generated real time injury reports from the location within the visual assisted communication to law enforcement and first responders within the radius.

A method for dynamically managing communication during an emergency situation at a school including receiving a dynamic feed of information from the school of the emergency situation, utilizing a processor to determine the school information and set up a radius around the school, utilizing the processor to transmit notification of the emergency situation messages to law enforcement and first responders located within the radius, providing dynamically generated real time visual assisted communication of the school from a database to law enforcement and first responders within the radius, and receiving dynamically generated real time injury reports from the school within the visual assisted communication to law enforcement and first responders within the radius.

### BACKGROUND

For years, the venue of First Responder Communication has had little drastic change, especially in the Law Enforcement space. Two-way radio communications have been the staple for Police, since migrating from call boxes on street corners. A majority of improvements within the past 20 years have been confined to improving the quality of this single system, and new technology created has been designed to support current radio systems. During this same time, there has been little convergence of technological advances from other platforms that would complement First Responder communications, exclusive of VHS/Radio communications. Even Computer-Assisted Dispatch (CAD), designed in part to reduce radio traffic and provide alternative information sharing, has been limited in its implementation and quality, especially for smaller Agencies with limited resources.

Communication technology in this domain has lagged behind the developments in the private sector technology. Mainly rooted in repetitive training and recycled mindsets, First Responder advancements have been hampered by a lack of creativeness, instead relying on entrenched mindsets that pass on processes for generations of Officers and staff.

The applicant is committed to increasing Public Safety. Our belief is that Public Safety starts at the local level, expanding outward to State and Federal partners. Since the average size of a Police Department in the United States is less than 50 sworn officers, the applicant is resolute in our ability to be both transformative and compatible. All of our technology is designed with the ability to integrate with small departments while retaining continuity through expansion into large organizations. This breaks the typical model of most First Responder technology advancements, which is usually derived from necessity for large departments or initiatives, only to be incompatible with small-force agencies.

Lateral Thinking is the applicant's primary objective to revolutionize First Responder Communications. We are determined to break through the confines restricting traditional networks. Our goals are focused toward complete transformation of Emergency Services communications utilizing wireless network technology and mobile application platforms. It is our belief and our experience that the keys to true advancement are commanded in this space, and the generations of future First Responders will already be completely immersed and acclimated to this technology through use in the private sector, social media, and recreation.

Advanced Technology Integration is the focal point of the applicant's mission and proposed partnership with cell providers. The optimal requirements for seamless integration into the First Responder technology space is creating and promoting applications the run on one platform with equivalent measures and processes, so that each application's features are congruent and facilitate training and retention.

Trend Development is essential for rapid expansion into the First Responder communications space. Trend Development requires three groups to be equal stakeholders in the progression into this tech area: Wireless Telecommunications Carrier(s), Emergency Services, and the Service Recipients. Applicant's first application, Critical Event Response Applications (CERA)—Schools, identifies Emergency Services as the local First Responders, and the Service Recipients, such as Teachers. The recipients receive the increase in safety and their vulnerability is greatly mitigated. Therefore, Service Recipients become the initiators of promotion and influence First Responder buy-in. Once Emergency Services implements the First Responder portion of Critical Event Response Applications (CERA), all future apps will run from the same platform, providing an invariable anchor that creates a seamless expansion of services.

There is an inability to manage critical communications as officers respond at different intervals, dispatchers have to repeat the same information multiple times. This clogs radio channels and reduces transmission capabilities. If the identity of a suspect is confirmed, Police have no way to even transmit a simple photograph to officers from other jurisdictions. With the application software, these weaknesses are eliminated. The application software of the present disclosure allows for teachers to send critical information to the Commanders. Further, Commanders can upload suspect information and photos to the application software, allowing any responding officer to access this critical data without using the radio.

### BRIEF DESCRIPTION OF THE DRAWINGS

The present disclosure will become more readily apparent from the specific description accompanied by the following drawings, in which:

FIG. 1 is a schematic of a sample a start screen in the application software as described in the present disclosure;

FIG. 2 is a schematic of a one embodiment of a lockdown screen in the application software described in the present disclosure;

FIG. 3 is a schematic of a one embodiment of a communication screen in the application software described in the present disclosure;

FIG. 4 is a schematic of a one embodiment of a floorplan screen in the application software described in the present disclosure;

FIG. 5 is a schematic of a one embodiment of a floorplan screen in the application software described in the present disclosure;

FIG. 6 is a schematic of a one embodiment of a video conference screen in the application software described in the present disclosure;

FIG. 7 is a schematic of a one embodiment of a video conference screen in the application software described in the present disclosure;

FIG. 8 is a schematic of a one embodiment of a video conference screen in the application software described in the present disclosure;

FIG. 9 is a schematic of a one embodiment of a video conference screen in the application software described in the present disclosure;

FIG. 10 is a schematic of a one embodiment of a video conference screen in the application software described in the present disclosure; and

FIG. 11 is a schematic of a one embodiment of a video conference screen in the application software described in the present disclosure.

### DETAILED DESCRIPTION

In some embodiments, transforming First Responder communication embraces the following concepts. Mobile Application Technology—They are used so regularly; society just refers to them as “apps.” Mobile apps have become the staple for which communication is passed back and forth. They are cost-effective to implement and have unlimited expansion potential to accommodate small to large organizations. Private sector businesses have embraced the use and development of mobile apps as a primary source of communication with consumers, as well as with their internal administration. For an analogy with the First Responder platform, the agencies are the business its citizens are the consumers. Mobile application software affords communication with single and multiple people, while providing simplified function, lessoning the learning curve for use. Moreover, mobile apps can easily merge and interconnect multiple organizations on a single platform, while allowing the singular institution to still maintain sequestered individual and internal communication.

Visual-Assisted Communications—The most crucial requirement for First Responder organizations, visual-assisted communications need to be systematically infused into their platform. The current majorities of emergency personnel rely solely on audio communication and are limited to the visualizing the threat landscape only mentally, based on knowledge and past experience.

Visual assistance is already required in First Responder communications. Most critical event scenes require the commanders to enlist a scribe to draw diagrams, mark times and keep written notes of the events. This sole reason for this is so Commanders can access and review personnel locations, actions taken, determine further actions needed, and record decisions for debrief and training after the event. They need a visual perspective.

First Responders also require visual imagery of a threat landscape. For example, when law enforcement pursues a fleeing suspect, their first protocol is to form a perimeter around the area to prevent escape. The perimeter, commonly referred to as a “box,” requires officers to form a line-of-sight border around the area, in which every perimeter line can be visually sustained by officers. Maintaining these visible perimeter lines allows the police to ensure the suspect does not escape the search area. For this to happen, the Officer in Charge (OIC) needs to set and staff at least four perimeter points, located at the corners of the box, allowing for each officer to view the other staff on the plotted points connecting them. That means the OIC must know the visual landscape of the terrain, including street names, intersections and visual connections. This can prove difficult when the OIC is new, under stress or at a location with which s/he is not familiar from experience. What is lacking is a visual depiction of the location for use as a template.

Applicant's mission is to implement long-term Visual-Assisted Communication to First Responders. It is a tremendous tool that can be made readily available for existing personnel in Emergency Operations. But moreover, the new and future First Responders are already committed and dependent on visual communication. According to Forbes Magazine, 68% of individuals ages 18-29 prefer texting (a form of visual communication) and phone call usage (a form of audio communication) has plummeted. It is vital to understand the value that is provided in statistical data of consumer communication preferences. These consumers are also new and future First Responders, and this age group represents the majority of the candidate pool. One of the greatest challenges faced with new and prospective law enforcement candidates is training them how to comprehend their location and course of travel, which is an absolute necessity for dispatchers and other personnel to possess. When investigating why this challenge is so problematic, the sole contributor is the reliance on everyday mobile mapping applications. From Google Maps to Waze, citizens no longer rely on memorizing directions, street names or even compass direction. An application software provides all this data for them. Yet all of this information is required in an emergency situation, before the situation begins. A police officer's safety always relies on them knowing their present location. No matter what street, alley or structure they are patrolling, the Officer must immediately be able to provide his/her coordinates on if an immediate emergency erupts. The future candidates of Policing have little concept for this, as their entire life span has been trained to rely not on memory and experience, but a technological application. This is further exacerbated under stress, such as a vehicle pursuit, when compass direction and street identifiers are required to provide in order to receive backup and assistance.

Applicant's mobile application software provides law enforcement tools to accomplish the missions of First Responders while embracing the mindset and capabilities of new generations. Instead of struggling to train against or retrain the rapidly-evolving skills programmed in young candidates, the applicant provides the platform for generations of these new and future First Responders to thrive.

Critical Event Network Transmissions (CENT)—CENT are pre-categorized emergencies that require a rapid mass law enforcement and emergency services response. Active killer, mass casualty incidents, and disasters will be managed under individual Critical Event Response Applications (CERA). The key to successful management of these incidents is rapid response and communication. Applicant is prepared to deliver application software for each critical event, which would all operate under the CENT platform. All measures, tasks and actions will be integrated into CENT and be standardized, so that Commanders and front-line personnel learn and perform the similar functions, allowing for easier training and retention. Moreover, every department or agency utilizing CENT will have a universal action system that all contingents understand and follow. Applicant's Critical Event Network Transmissions and application software will conform to ICS/NIMS standards where applicable and promote unity of command.

The First Response system of the present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. Also, in some embodiments, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily superior” and “inferior”.

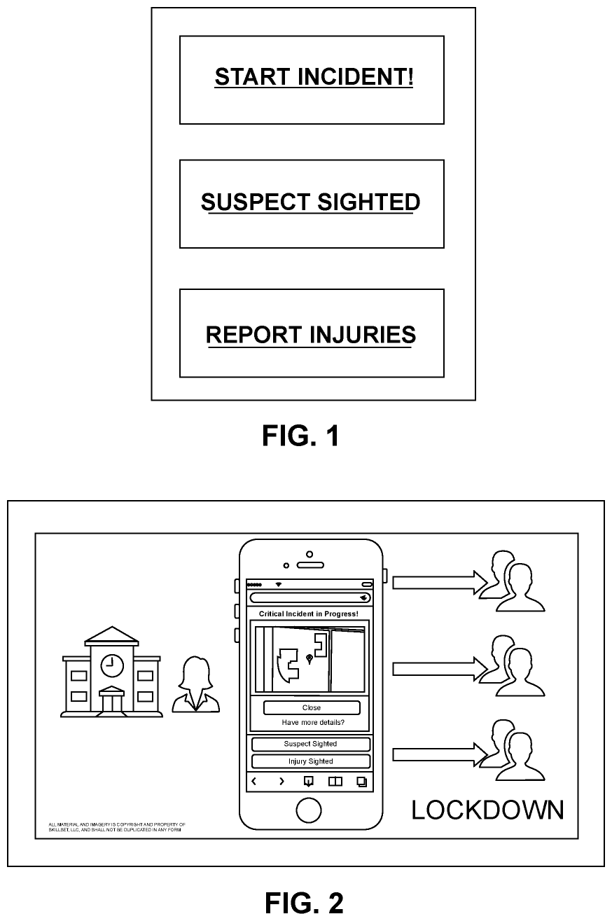

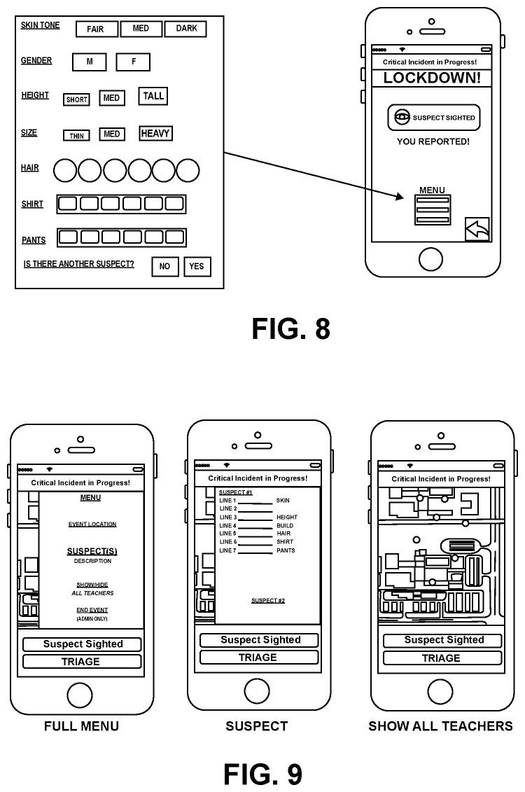

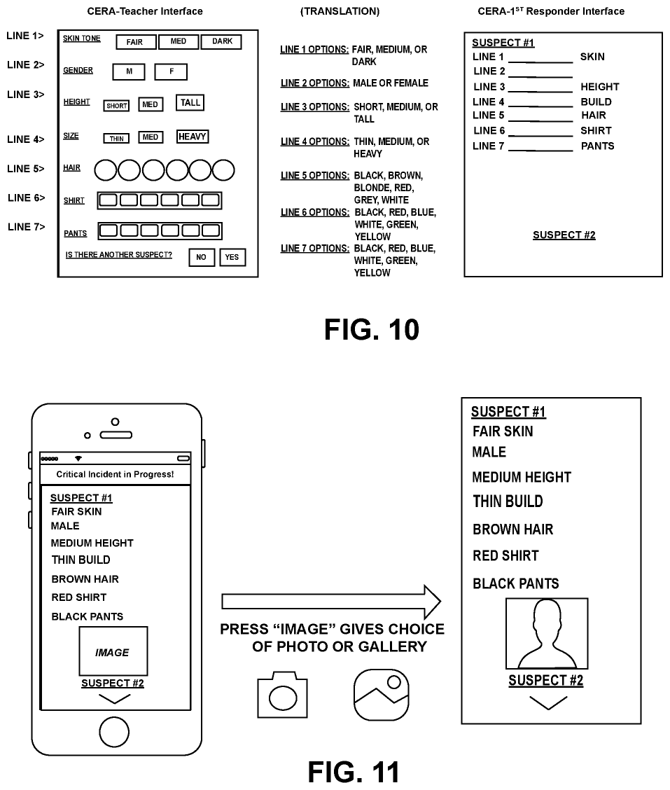

The following discussion includes a description of a First Responder system and related components and methods of employing the system in accordance with the principles of the present disclosure. Alternate embodiments are also disclosed. Reference is made in detail to the exemplary embodiments of the present disclosure, which are illustrated in the accompanying figures. Turning to FIGS. 1-11, there are illustrated components of a method for dynamically managing communication during an emergency situation, in accordance with the principles of the present disclosure.

The method for dynamically managing communication during an emergency situation comprises receiving a dynamic feed of information from a location of the emergency situation; utilizing a processor to determine the location information of the emergency situation and set up a radius around the location; utilizing the processor to transmit notification of the emergency situation messages to law enforcement and first responders located within the radius; providing dynamically generated real time visual assisted communication from a database to law enforcement and first responders within the radius; and receiving dynamically generated real time injury reports from the location within the visual assisted communication to law enforcement and first responders within the radius. An example of use of this method is described below with respect to an emergency situation including a school shooting.

The increasing number of mass shootings, especially in our children's schools, has reached critical mass. Police and emergency personnel are waging a constant battle against time to receive critical information, time to respond and stop the threat time to treat the injured.

Traditional communication with First Responders and the public has been failing. Since the early 1900s, there has been little change in the way our emergency personnel receive and send critical information. Two-way radios are still commonplace, allowing only one person to transmit critical information at a time. As radio frequencies become congested, communication systems start failing.

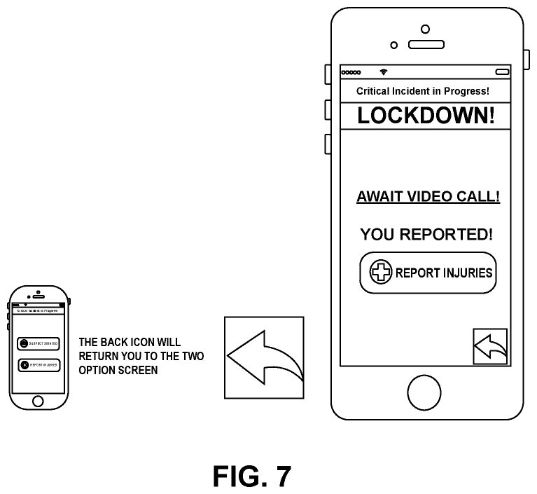

As multiple jurisdictions respond to the critical incident, many do not have the ability to communicate with each other, or pass on critical visual information, locations, and mapping. As multiple jurisdictions respond to the critical incident, many do not have the ability to communicate with each other, or pass on critical visual information, locations, and mapping. Every second matters and can save lives. The application software is designed to directly merge teachers, law enforcement and First Responders in one single application software. Real time information on suspects, locations and injuries, all immediately available to Public Safety personnel, as shown in FIGS. 7-11. Teachers will no longer wait helplessly. They will be providing the critical information needed to bring a crisis to rapid conclusion.

Our outdated communications systems leave us unprepared to succeed in a rapidly evolving critical event. With time being of the utmost importance, the steps needed in our current system debilitate the response, with every emergency call requiring four steps: the 911 call, the operator to receive the message, the dispatcher to provide the information from the operator to emergency personnel, and the 1st responders to react. With the application software, these steps are reduced or eliminated. Application software has two facets: the School App and the First Responder App. Schools will join the Critical Event Response Applications (CERA) School app, and administer their own account. Teachers will download the app to their mobile devices. In the event of a critical incident/mass shooting, the teachers can simply press one button on their phone to start an event.

The Application software looks similar to a traffic signal. Its simplicity allows for minimal thinking and dexterity during the high stress of a critical event. Once one teacher at the school presses—*START INCIDENT! No other teachers in the school will be able to activate this red button. Every report from a teacher after this incident will be—*SUSPECT SIGHTED or an—Injury Reported.

Once one teacher or administrator starts an incident, every other teacher in that school will receive a loud, audible and vibrating emergency notification on their mobile device or computer, indicating there is an active killer on the campus. Immediately, every class will go to “Lockdown” mode. Teachers and student will begin their preparations to shelter in place within seconds of the first notification, reducing the suspect's ability to find and access victims.

Simultaneously, the application software notifies every law enforcement officer, police agency and emergency response unit within a pre-set radius of the school, regardless of jurisdiction. These agencies have the First Responder portion of the application software, which allows them to manage the scene also immediately as it unfolds. There will no longer be the delay from 911 call to dispatch to officer. Every police officer within the preset radius, even off duty, will receive the emergency call from the school.

As officers and emergency personnel begin their rapid response, they will have immediate access to the map of the school. GPS mapped icons will show exactly where the incident started on the campus, and with every real time update from teachers that there is “SUSPECT SIGHTED” application software confirms and plots the closest proximity to the suspect. Officers will now be able to respond directly to the threat, even at a location for which they are not familiar. As Medical personnel move toward the locations, they will be able to see where injured students and teachers are located, and can begin planning immediately for what's needed upon arrival.

For the Commanders on scene, management is at their fingertips. As reports generate real time on the map, the Officers in Charge, or OIC, can immediately plan and coordinate the response. All responding officers logged onto the application software, will appear on the display through live GPS Tracking. Regardless of which agency is responding, the OIC can see by the icon the officer's Department and Identification number. The OIC can then direct any officer, as needed, to engage the suspect, establish perimeters or treat injured.

Rapid response, real time updates from teachers imbedded in the crisis, Visual mapping and control, all directly from the Command Post. These dynamics shift the success rate for Law enforcement to save live.

For Emergency medical personnel, their capabilities are even more enhanced. Once relegated to standby until the scene is safe enough for them to enter and treat wounded, first responders can now immediately begin to locate where the injured are on campus. They can triage the injuries, determine priorities for medical treatment, and even provide critical first aid remotely through the application software.

EMS can contact the reporting teacher through the application software's Emergency Video Conference feature. The teacher or administrator who reported the injury can advise Paramedics of the extent of injuries on scene.

Further, Paramedics can view the injuries through the video feature. They can then provide mobile lifesaving first aid instructions to the staff and students, significantly increasing survivability. Additionally, EMS can prioritize medical evacuations, based on the extent of the injuries they now know are on scene. If necessary, EMS and Police can coordinate rescue extraction teams, now having the knowledge of the suspect's location as well as the location of injured persons.

One of the hardest lessons learned during the response to the Marjory Stoneman Douglas School shooting was the inability for officers to communicate critical information during the event. As officers began responding toward the school, they would have to ask the description of the suspect. Even after the dispatcher would relay this information over the radio, new officers responding after the transmission would require repetition of the description. This exacerbated the clogged radio channels and reduced the capabilities of the communication systems. Further, once the identity of the suspect had been confirmed, there was no way to transmit a simple photograph of him to the multitude of officers from various jurisdictions. During MSD, officers were constrained by this inability, limiting them to having to verbally read off the suspect's Instagram handle over the radio in order for other officers to look up a photo. With the application software, these weaknesses are eliminated. The application software allows for teachers to text critical identification or descriptive information to the application software. Further, the OIC can upload suspect information, and photos if available, to the application software, allowing any officer responding to access this critical information.

For example, in use, the administration for a school creates an account in the application software, and assigns an account administrator from the school. The only prerequisite is that at least one agency from the school's jurisdiction or neighboring jurisdiction pledges to sponsor the school. The administration adds all teachers and administrative personnel. Each user profile will require your name, your cell number, a profile photo, and your regular room number. Each user will be sent an invite with a temporary password. Once you open your user account and download the application software, you can create your own unique password. The application software is very simplified, designed that way to be used under high stress. It is designed like a traffic light, think of a red, yellow and green light.

The application software is only operational when a teacher is in a school that has an application software account. Once they leave the area, the application software deactivates. The application software works in any school on the platform, so if you as a teacher go to another school one day, your application software will activate.

A teacher can have the widget of the application software displayed on their home screen. In the event of an active shooter, the teacher opens the widget. The first button, the red light, activates the signal for ACTIVE SHOOTER, as shown in FIG. 1.

Once an event is started, every teacher in that school receives a push notification, much like an Amber Alert, to immediately lockdown. When they open their app, it will immediately act as a homing beacon to show where teachers/students are sheltered in place, and they still have the option to report “SUSPECT SIGHTED” or “INJURIES REPORTED” or “POLICE/EMS RESPONSE”.

Police and EMS immediately receive a push notification, much like an amber alert, and emergency response commences to the school. While in route, the police notify dispatch of the signal, and can begin calling the school to validate the event.

A command post is set up and begins monitoring and/or guiding all officers responding. Every officer who has logged on to the event through the application software, can be observed by the department and a unique CCN, so command can know and guide officers to positions regardless of agency.

For EMS, as they respond, they can coordinate, based on the locations of the suspect and/or injured, the best areas for evacuation and on-scene treatment. As “INJURIES REPORTED” icons pop up, they can video call in to the teacher to mobile triage the extent of injuries, and if necessary, mobile—provide life-sustaining first aid guidance to assist the injured.

The Police/Fire Command Post can begin coordinating evacuation points based on a confirmed suspect location, reducing time to move victims to safety and treat wounded. Suspect information, from physical description to photo (if available) can be sent to all responding officers. As officers log on to the event, the description will be available without having to request over radio.

Current systems leave us unable to succeed in a rapidly evolving event. Time is of the essence. The steps needed in our current system slow the response, as every emergency requires 4 phases: The 911 call, the operator taking the notes, the dispatcher transmitting the call, and the first responders reacting. With the application software all of this changes. The application software has two facets: The School App and the First Responder App. Teachers join the School App and download it to their devices or computers. First responders will do the same in the First Responder APP. In a critical incident, the teachers simply press one button on their phone to start the response, anytime, anywhere on school property. The School App looks like a traffic signal. Its simplicity allows for minimal thinking and dexterity during high-stress critical events.

Once a teacher starts an incident, every other teacher in their school will receive a loud, audible and vibrating emergency notification on their device, indicating there is an active killer on campus. Within seconds, Teachers and students will LOCKDOWN and shelter in place, reducing the suspect's access to victims, as shown in FIG. 2.

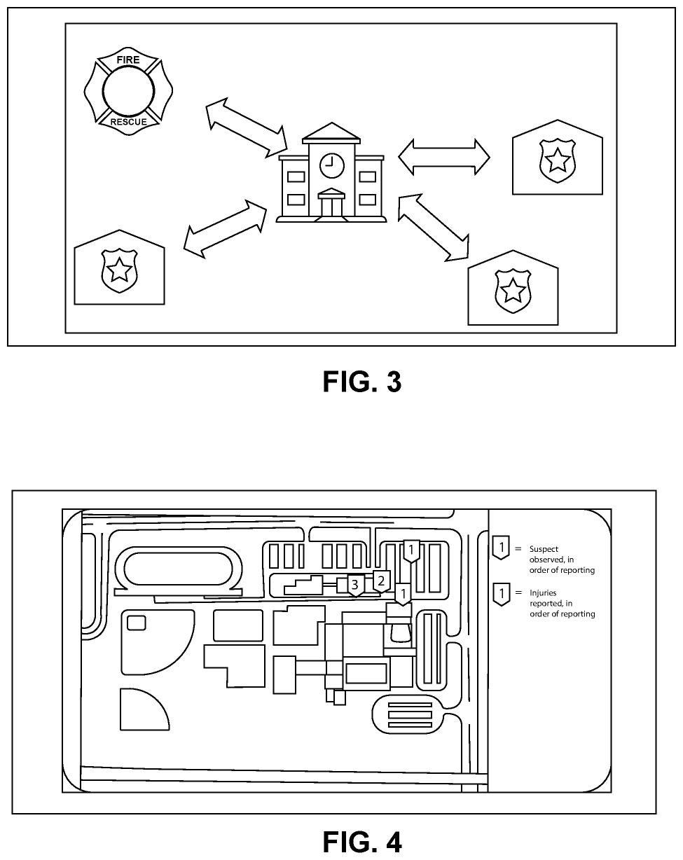

All first responders within a preset radius of the school will receive the instant alert on their device or Mobile Data Terminal, regardless of jurisdiction, and begin their rapid response, as shown in FIG. 3.

With every real time update from teachers through the “SUSPECT SIGHTED” feature, the application software plots the GPS location of the threat, as shown in FIG. 4. Police have immediate access to the map of the school and GPS plots of the suspect, and can respond rapidly, even to a school with which they are not familiar.

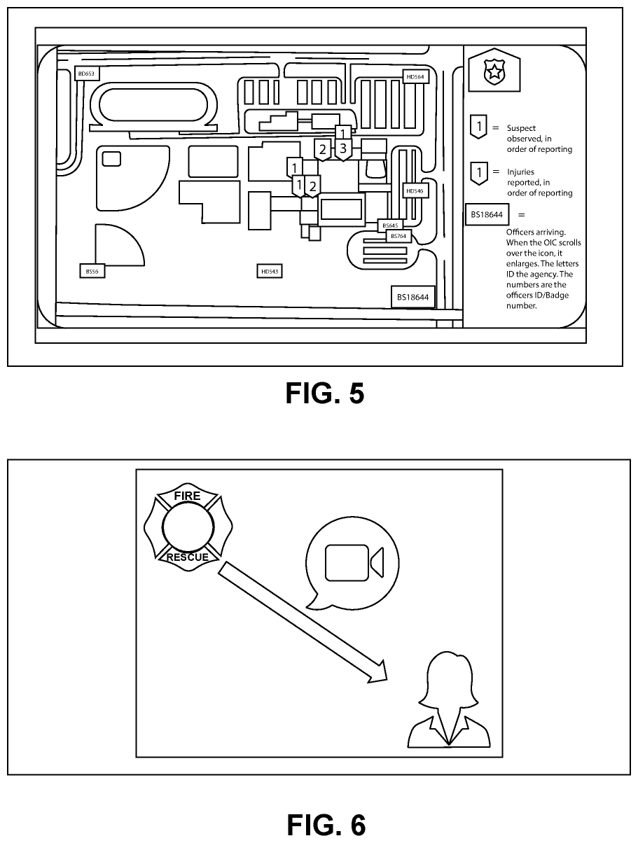

For Commanders on scene, management is at their fingertips. As teachers generate real time reports, Commanders can immediately coordinate the response. Officers logged on to the application software will appear on the display through live GPS Tracking, regardless of agency or jurisdiction, as shown in FIG. 5. Commanders can see the icons with each officer's Department and Identification number. Commanders can then direct officers to engage the suspect, establish perimeters or treat injured.

Rapid response, real time updates from teachers imbedded in the crisis and visual control. As Medics move toward the locations, they can see where injuries are through the Teachers “INJURIES REPORTED” feature. Their enhanced capabilities allow them to plan their arrival. Once relegated to wait until the scene is safe enough to enter, medics can now immediately begin to locate and triage injuries, and they can even provide critical first aid remotely through the application software's Emergency Video Conference feature, see FIG. 6. This allows medics to video-call teachers who report injuries and assess the severity. Medics can even view the injuries through the video feature, and provide mobile lifesaving first aid instructions, significantly increasing chances of survival until rescue arrives. Medics can also prioritize evacuations, based on the extent of the injuries they now know. If necessary, Medics and Police can coordinate rescue teams, now that they know both the suspect's location and the location of injured.

In some embodiments, the software application includes an interface component with Law Enforcement Officers. Law Enforcement Accountability and intelligence repository to threat reporting. Teacher report threats through the software application. Standard boxes to add all pertinent information, dates and photos immediately sent to commanders of the school's jurisdictional agency. Time-sensitive mandates to respond and investigate. If report is not followed up, next agency is notified (county, State, Federal). All reports must be completed marked, no action taken, intervention, arrest. Every agency in the matrix receives a notification of a completed incident. Accountability for progressive action for repeat offenders. All information is stored/encrypted for access only to Law Enforcement, so any agency or SRO can see history of offender's threats. The software application interfaces with Schools/First Responder. Touch-screen technology to click/drag Unit icons to desired position, and will immediately notify the Unit without radio use (via GPS). The software application will be configured to interface with hospitals to manage injuries reported. It will implement a five-tier triage system with a hospital/trauma doctor interface. The software application interfaces with non-educational special designated high-risk facilities such as government installations, military bases, airports, courthouses, large government campuses for event reporting.

In some embodiments, the software application includes an interface component with Students to allow for Students to communicate with First Responders. The software application interfaces with Students/Schools/First Responders. Touch-screen technology to click/drag Unit icons to desired position, and will immediately notify the Unit without radio use (via GPS). The software application will be configured to interface with hospitals to manage injuries reported. It will implement a five-tier triage system with a hospital/trauma doctor interface. The software application interfaces with non-educational special designated high-risk facilities such as government installations, military bases, airports, courthouses, large government campuses for event reporting.

In some embodiments, the software application includes an Application Programming Interface (API), which will allow different school panic applications to converge into one platform. This will allow police to work off one platform, even if schools are using different panic apps.

In some embodiments, the Police can use the software application for all incidents involving a search and/or perimeter. Supervisors will add the address of the location and be able to set perimeter points by tapping the screen. Once four perimeter points are created, the application will show the location with four points the perimeter. Officers will be able to see the perimeter on their map, and take positions required.

In some embodiments, in the Schools a biometric confirmation will be an added security measure to mitigate false alarms. Additionally, the software application will send school emails as messages to teachers and students as a daily feed (students cannot respond, they are all DO NOT REPLY messages). This keeps teachers and students engaged with the software application so its familiarity doesn't fade and render the software application unusable under pressure.

In some embodiments, the software application can be utilized by various types of organizations in emergencies, for example, schools, colleges/universities, government facilities, religious facilities, hospitals, airports, and large campus private businesses.

It is to be understood that the above-mentioned figures are only illustrative of the application of the principles of the present disclosure. Numerous modifications or alternative arrangements may be devised by those skilled in the art without departing from the spirit and scope of the present disclosure. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method for dynamically managing communication during an emergency situation comprising:
receiving a dynamic feed of information from a location of the emergency situation;
utilizing a processor to determine the location information of the emergency situation and set up a radius around the location;
utilizing the processor to transmit notification of the emergency situation messages to law enforcement and first responders located within the radius;
providing dynamically generated real time visual assisted communication from a database to law enforcement and first responders within the radius; and
receiving dynamically generated real time injury reports from the location within the visual assisted communication to law enforcement and first responders within the radius.

2. The method of claim 1, further comprising receiving dynamically generated real time suspect information and providing the suspect information within the visual assisted communication to law enforcement and first responders within the radius.

3. The method of claim 1, wherein the visual assisted communication includes a map obtained from the database of the location.

4. The method of claim 3, wherein the map includes a schematic of a building in which the emergency situation is located.

5. The method of claim 4, further comprising showing the injury reports on the map to allow first responders to coordinate and locate the injured.

6. The method of claim 2, further comprising showing received suspect information on a map to allow law enforcement to coordinate tracking the suspect.

7. The method of claim 1, further comprising receiving a dynamic feed of updated real time information from law enforcement and first responders and based on the received updated information adjust coordination of law enforcement and first responders.

8. The method of claim 1 wherein the emergency situation is selected from a group of pre-categorized critical event network transmissions that require rapid mass response by law enforcement and first responders.

9. The method of claim 8 wherein the emergency situation includes a shooting at a school.

10. The method of claim 9 wherein the dynamic feed of information from the location of the emergency situation includes information from at least one teacher located at the school.

11. The method of claim 10 wherein the processor transmits messages to all of the teachers at the school.

12. The method of claim 9 wherein the processor transmits messages to all of the students at the school.

13. A computer implemented method (CIM) comprising:
dynamically determining a location of the emergency situation;
responsive to each dynamic determination:
calculating a radius around the location,
transmitting notification of the emergency situation to law enforcement and first responders, within the radius, including the location of the emergency situation;
providing dynamically generated real time visual assisted communication from a database to law enforcement and first responders within the radius; and
receiving dynamically generated real time injury reports from the location within the visual assisted communication to law enforcement and first responders within the radius.

14. The CIM of claim 13, further comprising receiving dynamically generated real time suspect information and providing the suspect information within the visual assisted communication to law enforcement and first responders within the radius.

15. The CIM of claim 13, wherein the visual assisted communication includes a map obtained from the database of the location.

16. The CIM of claim 13, wherein the map includes a schematic of a building in which the emergency situation is located.

17. The CIM of claim 13, further comprising showing the injury reports on the map to allow first responders to coordinate and locate the injured.

18. The method of claim 13, further comprising showing received suspect information on a map to allow law enforcement to coordinate tracking the suspect.

19. A method for dynamically managing communication during an emergency situation at a school comprising:
receiving a dynamic feed of information from the school of the emergency situation;
utilizing a processor to determine the school information and set up a radius around the school;
utilizing the processor to transmit notification of the emergency situation messages to law enforcement and first responders located within the radius;
providing dynamically generated real time visual assisted communication of the school from a database to law enforcement and first responders within the radius; and
receiving dynamically generated real time injury reports from the school within the visual assisted communication to law enforcement and first responders within the radius.

20. The method of claim 19, further comprising receiving dynamically generated real time suspect information from the school and providing the suspect information within the visual assisted communication to law enforcement and first responders within the radius.
